(19) United States
(12) Patent Application Publication
(10) Pub. No.: US 2009/0048892 A1
(43) Pub. Date: Feb. 19, 2009

(54) COMMUNICATION SYSTEM AND METHOD

(76) Inventor: Christopher Louis HARMS, Melbourne (AU)

Correspondence Address: LATIMER, MAYBERRY & MATTHEWS IP LAW, LLP, 13873 PARK CENTER ROAD, SUITE 106, HERNDON, VA, 20171, US

(21) Appl. No.: 12/090,882

(22) PCT Filed: Oct. 20, 2006
(86) PCT No.: PCT/AU2006/001559

§ 371 Date: May 19, 2008

(30) Foreign Application Priority Data
Oct. 21, 2005 (AU) 2005905814
Feb. 7, 2006 (AU) 2006900574

(51) Int. Cl. G06Q 10/00; G06F 9/46; H04M 1/00

(52) U.S. Cl. 705/8; 705/1; 455/550.1

(57) ABSTRACT

The embodiment discloses, in one form, multimedia communications, including remote publishing, mobile devices, network and on-line forms of communications. The embodiment also discloses a new electronic portfolio, communications, education commerce and fund raising platform, particularly useful for Community groups. In one form, it will enable Community groups to publish Community member-derived new-media content on a secure Community web page and make this content available, via a low cost subscription model and through any electronic communication device to interested and approved Community members.

### FIELD OF INVENTION

The present invention relates to the field of communications.

In one form, the present invention relates to multimedia communications, including remote publishing, mobile devices, network and on-line forms of communications.

In one arrangement there is provided a platform that delivers software allowing the creation, distribution and collaboration of content through an electronic portfolio. The platform delivers communications capabilities, educational benefits, commerce functionality and fund raising outcomes that are particularly useful for Communities.

It will be convenient to hereinafter describe the invention in a manner which relates to specific Community types, however it should be appreciated that the present invention is not limited to any specific Community type.

As used in the present specification the term Community is to be understood as embracing a group of people, a group of people forming a physical community in the physical world, and also communities covering a network of people, machines or servers or an individual per se. In general a Community consists of a group of people who exhibit behaviour that benefits the Community.

### BACKGROUND ART

The discussion throughout this specification comes about due to the realisation of the inventors and/or the identification of certain prior art problems by the inventors.

Prior art communication platforms are often directed to only a single aspect of communications, such as content development, content transmission and content viewing.

Prior art systems are also considered to suffer from a variety of problems and fail to address a number of needs, which include but are not limited to:
Cumbersome publishing of digital assets to websites. The prior art tends to capture content and then edit the content using a PC before uploading to a website. This is relatively labour, equipment and expertise intensive and hence limits the volume and extent of material that is published.
The software for administration and organisation of digital assets is difficult to access, configure and complicated to use
New-media portfolios are relatively complicated to use regularly, are text heavy and are difficult environments to engage.
Internet Television and Radio broadcasts are difficult to establish and sustain, and to retain their immediacy and currency. Furthermore such systems retain content in a manner that is not considered secure.
On-demand broadcasting of Community news is difficult, time consuming and expensive.
Privacy on new-media portfolios and other extranet platforms has been limited to relatively simple username and password criteria.
Online training is considered impersonal and often has low effectiveness
Existing new-media content creation and distribution systems do not facilitate the immediate publishing and broadcast of new-media content to Community Members nor allow the Community to benefit from this.
Increased complexity, integration need and feature set of available hardware and software affects the ability of Community Members to rapidly and repeatably engage with effective and modern technology which publishes to and broadcasts from new-media portfolios.
Because Communities typically have limited availability of dedicated media capture equipment, regular use of such equipment by Community Members is not possible. Solving this problem by increased investment in such equipment is not practical or sustainable.
Publishing material to the web often requires Community members to attend special training, be proficient in programming and use difficult image manipulation, editing and publishing software.
It is not considered feasible to provide Community leaders and trainers with hardware such as laptop PCs, scanners, printers, networks and data projectors.
It is considered too expensive and ineffective to provide on-site support to training Community leaders and trainers to exploit laptop PCs, scanners, networks, data projectors, office software etc for the creation of new-media portfolios.
Hardware and software to maintain and populate Community new-media websites is considered too expensive, slow and difficult to use for many Communities
For most Communities, it is too expensive to build and operate a TV and/or Radio broadcasting capability within their Community.
Many Communities hold the view that it's too expensive and difficult to produce the volume of quality video material required to convert their current web site into site capable of acting as a television station.
Many Communities do not have the knowledge and expertise to develop their own broadcasting capabilities.
For most communities, it is too expensive to purchase, equip and operate a mobile TV broadcasting unit.
Many Communities have too few sustainable fund-raising options.
Many Communities do not have the knowledge and expertise to seek sustainable sponsorship.
Many Communities do not have the knowledge and expertise to generate sustainable surplus funds from sponsorship and other fund raising activities after sponsor obligations have been met.
Vendors and solution providers to Communities do not have a turnkey approach to the affordable and sustainable provision of products and services on-site to Communities.
Many Communities rely upon one-off grants from government and other sources to obtain products and services for the Community.
Many Communities cannot afford the cost of running websites capable of broadcasting high quality content to Community Members.
Many Communities have too few educationally sound, good health promoting and Community based fund-raising options.
Despite recognition of the value of Community new-media content to Community Members, Communities struggle to regularly distribute this new-media content to Community Members in a valuable way.
There is a need for new ways to communicate a Community's reputation, brand, values and events.
There is a need to develop new and simpler ways to deliver selective new media content to Community members without forcing members to select content that they do not require.
There is a need for new and simpler ways for Communities to engage their wider geographical Community and past Community members in current Community activities and events.
There is a need to develop systems and communication methods which enable a Community to develop, disseminate and distribute various forms of communications in a streamlined manner.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

An object of the present invention is to provide an improved communications system and method.

### SUMMARY OF INVENTION

### Method of Enabling Communications

The present invention provides, in one inventive aspect, a method of and/or apparatus for enabling communication between member(s) of a community, the method comprising the steps of providing content from at least one community member for distribution to at least one other member of the community, providing skills to support the provision of content, providing financial support for a network adapted to provide the communication, and providing distribution of the content.

The present invention provides, in another inventive aspect, a method of and/or apparatus for enabling the distribution of content between Community Members, the method comprising the steps of:
providing skills to support the creation, publishing and broadcasting of Community and third party content on a network
providing skills to support commercial models that utilise creation, publishing and broadcasting of Community and third party content
enabling the network to create, publish and broadcast Community and third party content
providing sustainable financial support which provides the Community with the ability to enable the provision of skills and the creation, publication and broadcast of the content

Preferably providing sustainable financial support provides the community with the ability to support other Community activities. The method may be embodied in an apparatus.

In a Community there are members who utilises the services of a Community. One example would be students in a school community. Part of the school community would include parents who are differentiated from students by not utilising the principal services from the Community. In an embodiment of the invention the students would generate the content and the parents would subscribe to view the content online. In this way sustainable financial support can be provided. Community members typically exhibit positive behaviour that benefits that Community.

### Network of Enabling Communications

The present invention provides, in another inventive aspect, a communications network and/or method adapted for enabling communication between member(s) of a community, the network comprising first means adapted to providing content from at least one community member for distribution to at least one member of the community, second means adapted to provide skills to support the first means, third means adapted to provide financial support for the network, and fourth means adapted to provide distribution of the content of the first means.

The present invention provides, in another inventive aspect, a communications network and/or method adapted for enabling communication between members) of a Community, the network comprising
first means adapted to distribute content between Community Members
second means adapted to provide skills to support the first means,
third means adapted to provide financial support for the network,
fourth means adapted to provide financial support for the Community
fifth means adapted to provide distribution of the content of the first means.

### Device for Enabling Communications

The present invention provides, in a further inventive aspect, a device adapted to communicate with a communications network, the device comprising first means adapted to capture media content, second means adapted to transmit the content to the network, and third means adapted to selectively enable operation the first and/or second means for communication with the network.

### Content Categorisation for Enabling Communications

The present invention also provides, in an aspect of invention, a method of and/or apparatus for categorising content in a communications device adapted for operation with a community communications network, the community network providing communications between member(s) of the community, the method comprising the steps of providing in the device, a first category directed at community access, and a second category directed at a selected group of members access.

The present invention also provides, in an aspect of invention, a method of and/or apparatus for categorising content in a communications device adapted for operation with a Community communications network, the Community network providing communications between Community Members, the method comprising the steps of providing in the device:
a first category directed at Community access
a second category directed at a selected group of members access.

### Development of a First Group of Members of a Physical Community

According to a further aspect of the invention there is provided a method of publishing content associated with of a physical community, the method comprising:

receiving and storing content associated with the progress and/or achievement of a first group of members of the physical community for viewing by second group of members, the second group having an interest in the progress and/or achievement of the first group of members;

limiting access to the stored content to the second group of members of the physical community such that a third group, exterior to the second group of members of the physical community, is not able to view the stored content; and

subject to payment providing the second group with access to the stored content such that the second group is able to view the stored content and as a result view the progress and/or achievement of the first group of members.

Preferably the second group of members consists of sub-groups respectively having an interest in a corresponding subgroup of the first group of members and the method includes limiting access to the received content from each of the subgroups of first group of members to the corresponding sub-group of the second group of members such that the remaining sub-groups of the second group are not provided with access to the stored content.

Preferably the content associated with the progress and/or achievement of a first group of members of the physical community is generated by the first group of members.

Advantageously, in a preferred form, the first group of members comprises a group of students and the sub-groups of the second group comprise parents and/or extended family of the group of students, each sub-group having an interest in a different one of the group of students. Thus in these embodiments the physical community comprises students and patents. A third group of the physical community may be provided with the ability to view the stored content irrespective of payment. The third group may comprise teachers.

In other embodiments the first group of members comprises a horse and the second group of members comprises a group of investors. In these embodiments the content is generated from, rather than by, the horse. Video imaging is preferably used.

In another aspect of the invention there is provided a method of publishing content associated with a physical community, the method comprising:

providing content from at least one community member for distribution to at least one other member of the community

correlating access to the content in the community on the basis of payment by the at least one other member of the community for said access

In a further aspect the invention there is provided a system for publishing content associated with members of a physical community, the system comprising:

means for receiving and storing content associated with the progress and/or achievement of a first group of members of the physical community

means for limiting access to the stored content to a second group of members of the physical community, the second group having an interest in the progress and/or achievement of the first group of members, and the access being limited such that a third group, exterior to the second group of members of the physical community, is not able to view the stored content; and

means for allowing the second group to view the stored content, subject to payment, and as a result view the progress and/or achievement of the first group of members.

### Funding Streams

In essence, the present invention identifies and releases sustainable funding streams which allow Communities to acquire appropriate technologies and access appropriate on-site technical, media production and professional training expertise to create and broadcast Community-relevant content.

Communities can do this, in one form, by utilizing the existing digital skills of their Community Members who can produce new media material which they publish and broadcast for the purposes of communication with Community Members, potential Community Members and their wider Community.

In the same way that today's television operators have established strong commercial models from the broadcasting of free-to-air and subscription-accessible content, Communities who own and operate their own television station can facilitate new commercial models to benefit their communities.

### Preferred Forms

In one form the invention enables Communities to capture, publish and broadcast Community Member produced new-media content on a secure Community internet service.

In another form it enables Communities to make this new-media content available to approved Community members through electronic communication devices such as mobile phones with video facilities.

In another form, services are implemented and delivered to the Community which enables the Community to offer subscription based services to Community Members which contributes to the fund raising objectives of the Community.

In another form, the present invention enables Community members who are members of multiple Communities to publish content to their Community of choice.

In another form, the present invention enables Community members to publish to other or multiple Communities, including third party Communities such as but not limited to “Youtube™” or “MySpace™”.

In another form, the present invention enables Communities to control, via limitation or expansion, the publishing capabilities of its Community Members.

In another form, services are implemented and delivered to the Community which enables the Community to improve and optimise communication outcomes with Community Members.

In another form, training is implemented and delivered to the Community which enables the Community to increase its capability to create, publish and broadcast new-media content.

In another form, training is implemented and delivered to the Community which enables the Community to increase its capability to develop and implement new commercial models and fund raising objectives within the Community.

In another form, services are implemented and delivered to the Community which enables the Community to successfully launch and sustain a communications system according to the invention.

In yet another form there is provided a commercial platform through which Communities can derive income by leveraging their brand, reputation and Community standing.

### Further Forms and Advantages

The present invention, in a number of preferred forms, has been found to result in a number of advantages. The advantages with reference to the preferred forms are listed below.
1. The use of mobile devices such as Mobile Phone and PDAs with Video and Camera capabilities to push media directly to a secure Community website.
2. The publishing process allows the automatic categorisation of content through software delivered on mobile devices within the present invention. The software application interrogates the devices serial number and other identifying features to attach ownership information to the content. This is a particularly advantageous feature of the invention.
3. The publishing process may, through the use of icons or other visual or content categorising methods, enable a Member of one Community, who is also a member of another Community, to distinguish to which Community, material can be published. The present invention may determine the actual or relative volume of published material to any particular Community by a Member or groups of Members, and advantageously, may use this actual or relative volume information as a biasing means when distributing funds or other resources between Communities.
4. Enables rapid production of broadcast content. Because of the proliferation of mobile devices enabling digital image capture amongst Community Members, all Community Member can act as field-based individual content production units. These Community Members are able to act as interviewer, camera operator and producer thereby increasing the amount of Community content available.
5. Enables on-demand broadcast of Community news. The software provides permission for the mobile handsets belonging to specified Community leaders and trainers to initiate messages to be broadcast to Community Members
6. Digital content management. The software restricts the ability of unauthorised Community Members from capturing, storing and retransmitting broadcast content.
7. Collaboration between Community Members. The software provides Community Members with the ability to directly collaborate online with other Community Members.
8. Fund Raising programs generate funds for equipment purchases. The commercial model that is delivered to Communities provides for the purchase of media equipment and all required services.
9. Fund Raising programs generate Community surplus funds. Communities can use this derived content and the natural loyalty Community members have toward a Community to drive these members to their channel, thereby creating the opportunity to promote products and services through this channel. The outcome of purchases derived from such promotions provides the Community with addition revenue.
10. Enables Live broadcasts to Community Members. The software can stream video to any device, including but not limited to handheld devices. This enables Communities to broadcast Community content relating to specific Community events to Community members.
11. Allows communities to concentrate their time, knowledge, training and financial investments into the one (converged) device and platform.
12. Delivers a single platform to the Community thereby allowing Communities to concentrate their time, knowledge, training and financial resources into a single platform delivering fund raising, training, professional support and membership communication.
13. Delivers in-built and sustainable processes for Communities to control and generate income through content production and broadcasting.
14. Empowers Communities to take on the role of telecommunication provider to their Community membership.
15. Empowers Communities with a commerce model that attracts revenues to the Community in exchange for its promotion of approved third party products and services.
16. Empowers Communities to customise how the invention is implemented within the Community.
17. Sustains a turnkey outcome for communities which includes but is not limited to the provision to the Community of:
   On-going technology training
   Assistance to establish the Community commerce model
   Professional develop for Community leaders and teachers
   Public and media relations support for Community leaders and teachers
   Support to acquire broadcasting skills
   Governance and open disclosure of revenue programs for to support the integrity and probity of the Community's commercial dealings associated with the present invention.

In one form it will enable Communities to leverage their reputation and brand through the co-provision of products and services to Community Members.

In one form it allows Communities to selectively control the delivery of new media content from third parties to Community Members.

In one form it allows Communities to selectively control their. Member's total Community publishing choices. For example, a school Community may with to allow its Members to publish to a Community sports club, but not publish to an online open Community, such as ‘Youtube’.

In one form it rationalises communication channels allowing Community Members to select one or more communication devices through which to receive their selected content.

Other aspects and preferred aspects are disclosed in the specification and/or defined in the appended claims, forming a part of the description of the invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not limitative of the present invention, and in which:

FIG. 1 illustrates an overview of a preferred embodiment of the present invention;

FIG. 2 illustrates a preferred embodiment of the present invention.

FIG. 3 illustrates common operating units in a simplification of FIG. 2.

FIG. 4 illustrates a community environment of a preferred embodiment of the invention.

### DETAILED DESCRIPTION

The embodiment provides a new electronic portfolio, communication, education and fund raising platform, which has many applications, but is particularly suitable for use by Community groups. It enables Community groups to publish Community member-derived new-media content to a secure Community online location and make this content available, via a subscription model to approved Community members.

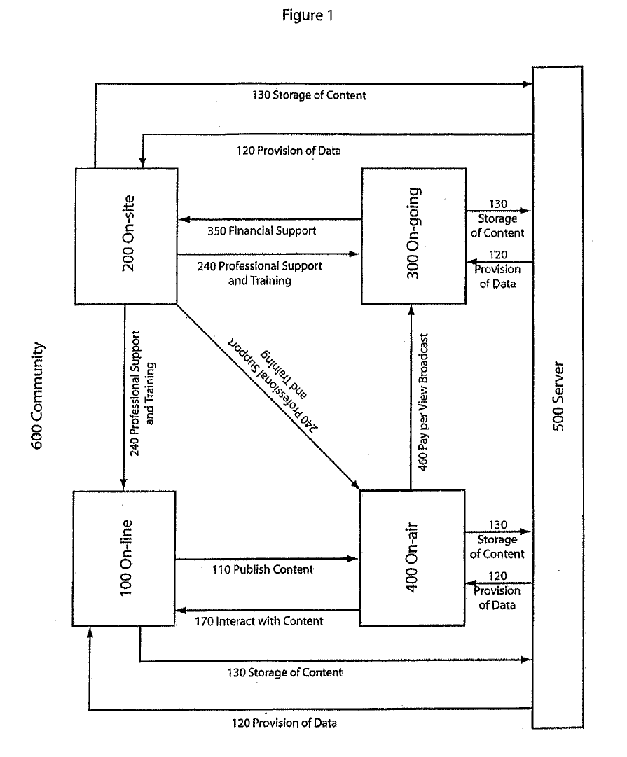

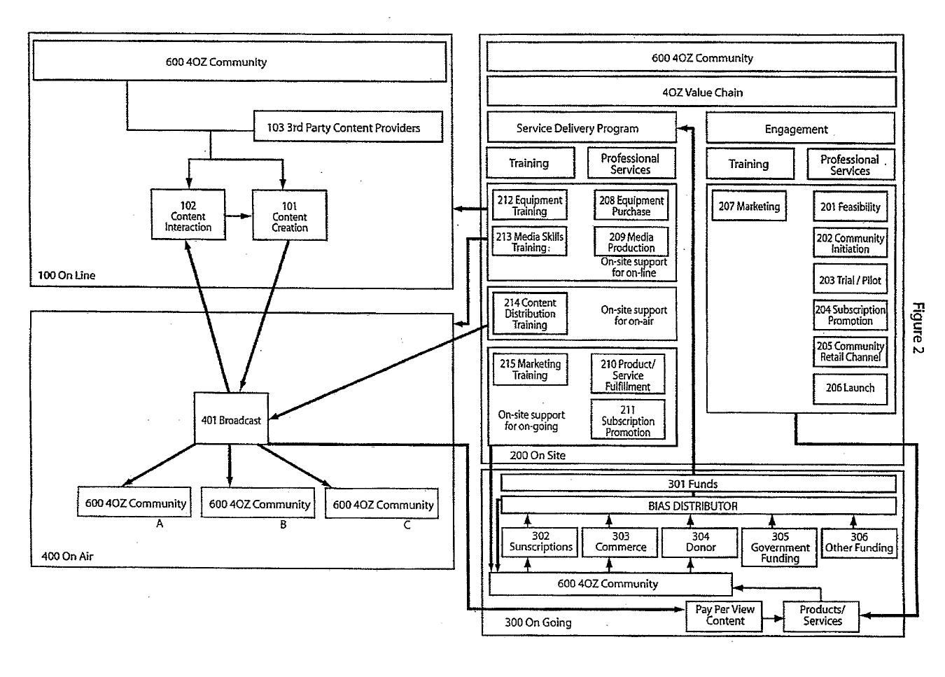

The embodiment is derived through the combination and interaction of four business process groups supported by a business logic platform. An illustration of the embodiment is shown in FIG. 1. Within 600 Community, there are four business process groups 100 On-Line, 200 On-Site, 300 On-Going and 400 On-Air supported by 500 Server.

The embodiment will now be described generally in the following section entitled “Overview of Embodiment” and then in detail in the section entitled “Detail of Embodiment”. Following that section there is provided a section entitled “Community Examples” that serves to explain how the details of the embodiment operate to provide a Community network.

### Overview of Embodiment

100 On-Line provides the mechanisms to capture, create and publish content and provides the mechanism to interact with this content and other data within the embodiment. Content is published 110 Publish Content via 130 Storage of Content for broadcast by 400 On-Air.

200 On-Site provides the mechanism for a Community to implement the embodiment within the Community and the mechanisms by which training, professional services and products are delivered to the Community. 240 Training and Professional Services are provided to deliver expertise and skills to the Community to support their use of the embodiment. The implementation of the embodiment requires configuration and branding that is stored within 500 Server through 130 Storage of Content.

300 On-Going is a business process that represents the commercial model that the Community uses to obtain the funds to launch and support the embodiment. The commercial model provides 350 Financial Support to support the On-Site processes of the embodiment. The transaction profile of the Community and Community members is stored within 500 Server through 130 Storage of Content.

400 On-Air provides the mechanisms to securely broadcast content stored within the embodiment to Community members. Broadcast content can be used for 170 Interact with Content in 100 On-Line to view, update and collaborate between Community members and can also be used to augment 105 Financial Support through 460 Pay per View Broadcast. 400 On-Air monitors and records content viewing and other interaction by Community members with 500 Server through 130 Storage of Content.

500 Server provides the business logic platform and data storage capability of the present embodiment to support 100 On-Line, 200 On-Site, 300 On-Going, 400 On-Air within 600 Community. 500 Server contains data and business logic which also supports the interaction between business processes.

The data within 500 Server includes but is not limited to the following:
Digital Media Assets, including meta-data
Community and Community Member Identity, including meta-data

500 Server provides 120 Provision of Data to 100 On-Line to support. Viewing, Interaction and Collaboration of content by and between Community members.

500 Server provides 120 Provision of Data to 200 On-Site to support the configuration, branding and customisation of the use of the present embodiment.

500 Server provides 120 Provision of Data to 300 On-Going to support the commercial model which controls access to content by the Community member.

500 Server provides 120 Provision of Data to 400 On-Air to direct the broadcasting of content to Community members.

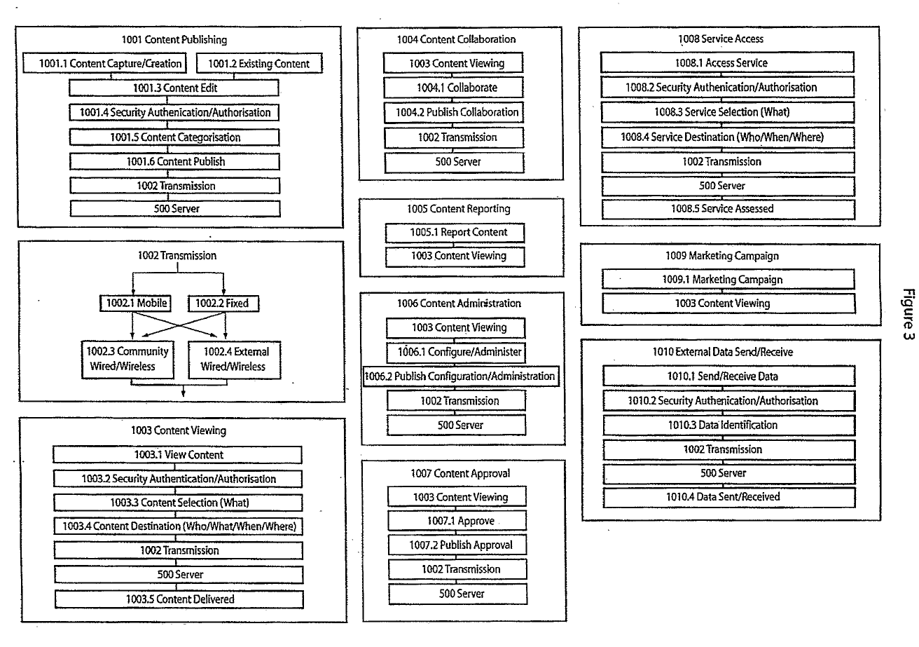

FIG. 2 shows the business processes for the four business process groups, 100 On-Line, 200 On-Site, 300 On-Going and 400 On-Air with respect to their interaction with 600 Community.

100 Online is the mechanism for communities to produce and derive their own content. This is achieved by communities acquiring new mobile multimedia technologies for their leaders and members, which will allow these communities to produce and publish their own content. The acquisition of new mobile multimedia technologies is funded via 200 On-Site.

There is an Internet Distribution Model from a Member's Web site to a Subscriber Base, including:

### Device Independent Publishing Method

The embodiment adopts a device independent publishing method comprising 101 Content Creation, shown in FIGS. 2 and 1001 Content Publishing shown in FIG. 3. The embodiment works by allowing IP based devices to transmit to 500 Server using a secure protocol.

### Fixed-Device Publishing

The embodiment recognises Digital Media Assets sourced from fixed devices including but not limited to; PCs, scanners, video cameras, still cameras etc and transmitted to 500 Server through 1001 Content Publishing.

### Mobile-Device Publishing

The embodiment recognises Digital Media Assets published from mobile devices by attaching the mobile device serial number and other device identifying information to the published material prior to transmission through 1002.1 Mobile shown in FIG. 3. This is particularly advantageous.

Integration with On-Site Digital Communications Protocol

The embodiment supports the on-site wired and wireless network connections that enable Community Members to utilise mobile devices without Telecommunications Network access at the on-site location. This is achieved through 1002.3 Community Wired/Wireless shown in FIG. 3. The embodiment contains software that identifies and recognises the availability to wired and/or wireless networks at the Community site and supports communication to 500 Server over these networks.

### Smart Selection of Network Access Technique

At 1002 Content Transmission The embodiment supports technology that selects the most appropriate method of communication based on the available options at the geography of the Community facilities. The embodiment contains software that scans for all available wired and/or wireless communication networks including, but not limited to:
ActiveSync via PC
Wireless (Wifi, 802.11/a/b/g)
Telco Wireless (CDMA/GSM/3G)
Modem Connection
Bluetooth
Infrared Beam

and based on 500 Server business logic where member publishing preferences are stored selects the most appropriate connection method based on available parameters.

### Customised Telephony Operation for Community Needs

Some Communities require assistance in teaching Community Members in appropriate methods and etiquette of electronic communication, including the capturing of appropriate content.

The embodiment allows Communities to customise the telecommunications features of any particular device and any particular Community Member thus allowing the Community to exercise usage control of Community Member devices. This is achieved through handset software regularly polling the 500 Server to retrieve handset configuration parameters.

The customisation features include but are not limited to:
Ability to use a calendar to control usage and availability of features
Implementing ‘black’ or ‘white’ lists which filter specific features for specific Community Members
Implementation of GPS functions enabling Communities to offer location-based support or assistance to Community Members

### Internet Television/Radio Station

At 401 Broadcast the embodiment enables Communities to create, publish and broadcast their own content through Internet Television or Radio station on a sustainable basis.

### Special Interest Group Internet Television/Radio Stations

Furthermore the embodiment enables special interest groups within Communities to create, publish and broadcast their own special interest group content through Internet Television or Radio station on a sustainable basis through 401 Broadcast shown in FIG. 2.

### Customised Messaging to Subscriber Groups

The embodiment contains software which allows Community leaders and others to create a category of content called Breaking News that can be immediately distributed by 500 Server to Community Members via 101 Content Creation to 401 Broadcast to 600 Community.

Communities can bundle packaged messages to devices not limited to mobile phones and web sites on a live basis.

### Customised Alerting to Community Members

The embodiment contains software which allows Communities to push out live alerts to Community Members using available electronic messaging techniques to any device.

Content Distribution based on Subscriber Status and Capability

The embodiment recognises device capability and the subscriber profile prior to receiving or delivering specific types of content to that subscriber at 1003.4 Content Destination.

### Publishing Control

The embodiment contains software that permits multi-tiered publishing review and authority to allow Community Executives to exert control on what content can be published to Community Member with or without approval. This will ensure Community publishing standards are met. Content creation, publishing and approval routines are shown as 101 Content Creation, 1001 Content Publishing, 1007 Content Approval in FIG. 3.

Publishing from a Community Studio

At 101 Content Creation the embodiment enables existing or new onsite content production facilities to be utilised for the production and publication of Digital Media Assets.

Publishing from a Mobile Studio

At 209 Media Production The embodiment enables Communities to access a mobile studio with production facilities connected to 500 Server for the recording, production and broadcasting of important Community events.

### Content Ownership Security

The embodiment employs secure server based delivery technologies which minimises the ability of the online audience to capture and/or separately distribute any content broadcast by the system. This is partly shown as 401 Broadcast, 500 Server.

### On-Air Rating System

At 102 Content Interaction the embodiment contains software which tracks usage of individual content. The embodiment contains software which content individual member's access.

The embodiment contains software that provides Community leaders and trainers with different layers of visibility of membership usage that can determine which Community Members have viewed particular digital material. The embodiment contains software that determines how many Community Members are logged on at any time. These modules are provided at 1003 Content Viewing and 1005 Content Reporting.

### On-Air Market Research Polling Systems

The embodiment will allow Community Members to participate in online secure, privacy-sensitive market research. This is partly shown at 1008 Service Access.

### Subscriber Registration

The embodiment allows the use of secure and external identification criteria during registration limited but not limited to the following:
drivers license
passport
welfare documentation
biometric
smart card technologies

Once registered subscription data is used at 302 Subscriptions and 1001.4 Security Authentication/Authorisation.

### Community Livery Template System

The embodiment provides the ability to utilise a template driven process to deliver the Community channel look and feel including template driven Community Member web sites, special interest web sites and Television/Radio websites. This is achieved by Community Administrators selectively configuring and capturing their Community's digital assets including but not limited to:
Community logos
Community photos
Community videos
Community colouring
Community styles
Community words
Community animations
Community audio

Community Initiation occurs at 202 Community Initiation.

### Personalisation Tools for Channel Content

The embodiment enables the downloading of digital personalisation material, allowing Community Members to personalise their websites to reflect their preferences and interests. After content creation at 101 Content Creation and subsequent publishing content viewing can occur at 1003 Content Viewing.

### Subscriber Promotion Marketing

The embodiment leads the development and implementation of a marketing promotion program to assist the Community to acquire Subscribers. Subscriber Promotion and Marketing occurs at 204 Subscriber Promotion, 211 Subscriber Promotion, and 1009 Marketing Campaign. The marketing and promotion program utilises fund-raising material including but not limited to: subscriber information kit, subscriber application form, subscriber confirmation form, subscriber report for the Community

### Community Subscription Sales and Fulfillment

The embodiment leads the sales of Subscriptions from Subscribers to the Community on behalf of the Community at 302 Subscriptions.

The embodiment gives responsibility for the fulfillment to Members for all requirements regarding the program to the Community. This is shown at 210 Product/Service Fulfillment.

### Community Channel Launch

At 206 Launch the embodiment conducts the launch of the program to Community Members and assists the Community to publicly launch the program through Community Members briefings using material, Community newsletter briefings and public relations campaigns.

### Community Program Training for Community Members

The embodiment provides training both at the time of fulfillment and at other times for equipment and processes provided during the subscription program. The provision of this training is shown at 212 Equipment Training, and 213 Media Skills Training.

### Community Program Training for Community Executive

The embodiment provides training for Community Executives and others to assist them to effectively communicate with Community Members Subscribers and other Community interests. The provision of this training is shown at 207 Marketing Training, 214 Content Distribution Training, and 215 Marketing Training.

### Community Channel Production Overview and Management

The embodiment provides professional services to assist Communities in regularly producing and promotion material for broadcast to Community Members. The embodiment achieves this through executing a systematic process that assists Community leaders and trainers to produce on-going material. These services include 209 Media Production, 213 Media Skills Training, and 214 Content Distribution Training.

### Introduction of New Revenue Items

An aspect of the embodiment is the sharing of all revenues raised with the Community, thus leveraging the Community's good standing and reputation with its Community Members. This revenue sharing model allows the program to be self-sustainable and encourages the Community to promote further products and services to the Community Members using similar methods. Reference in this respect is made to 350 Financial Support and 301 Funds.

### Telecommunications Package

The embodiment allows Communities to offer telecommunication products and services for purchase by Community Members and others for telecommunications products and services including, but not limited to broadband, landline, mobile, wireless communications, internet TV, video on demand etc. This is shown generally at 303 Commerce and 210 Product Service/Fulfillment.

### Household Utilities Package

The embodiment allows Communities to offer utilities products and services for purchase to Community Members and others for products and services including, but not limited to gas, power, water and other services. This is shown generally at 303 Commerce and 210 Product Service/Fulfillment.

### Household Banking/Finance Package

The embodiment allows Communities to offer financial products and services for purchase by Community Members and others for products and services including, but not limited to household insurance, mortgages, credit/debit cards, credit instruments, deposit etc. This is shown generally at 303 Commerce and 210 Product Service/Fulfillment.

### Household Electronics Package

The embodiment allows Communities to offer electronic products and services for purchase by Community Members and others for products and services including, but not limited to household electronics including TVs, hi-fi, multimedia products, etc. This is shown generally at 303 Commerce and 210 Product Service/Fulfillment.

### Household Local Traders Package

The embodiment allows Communities to offer products and services from local traders for purchase by Community Members and others for products and services including, but not limited to fast food, trades services, building services, etc.

### Conversion of Digital Images to Print

The embodiment allows Communities to offer printing of digital images products and services for purchase by Community Members and others for photo products and services including, but not limited to digital prints.

### Market Research Polling Revenue

The embodiment allows Communities to offer survey products and services for purchase by Community Members and others for products and services including, but not limited to online surveys. This is shown generally at 303 Commerce and 1008 Service Access.

### Introduction and Management of New Content to Community Channel

The embodiment allows Communities to introduce new third party content for purchase by Community Members. Reference in this respect is made to 303 Commerce, 1008 Service Access, 401 Broadcast, 006 Pay per View Broadcast, and 1003 Content Viewing.

Such content can include but is not limited to:
Masterclass content in the dramatic arts, music and entertainment
Masterclass sporting content

### Other

The embodiment allows Communities to offer for purchase other products and services by Community Members and others for other products and services not stated here. Purpose of these yet to be determined products is to allow Communities to increase their revenue generation amongst their Community membership.

### Community Revenue Model for Online Survey

The embodiment allows Community Members to subscribe to online surveys which can generate funds from the surveyor and to proportion those funds for Community use. This occurs at 303 Commerce.

### Community Loyalty Scheme

The embodiment allows Communities to offer a Community loyalty program which rewards Community Members who support the Community's programs. This occurs at 303 Commerce.

### Community Donor Programs

The embodiment allows Communities to implement Community Donor Programs. The embodiment contains software which uses Donor profiles, history, contact details, stated preferences and other donor information to implement Donor communications, Donor events and other Donor related activities in order to maximise the revenue generation from Donors to the Community. This is generally shown at 304 Donors.

### Detail of Embodiment

Further detail within the embodiment will now be described with reference to FIG. 2, split into the following sections representing the interaction of the Community with the embodiment. It is to be noted that the present invention may equally be applied to multiple communities, and/or multiple members within a community.
Step 1—Commencement
Step 2—Fundraising
Step 3—Service Delivery
Step 4—Content Production
Step 5—Broadcasting
Step 6—Content Collaboration
Step 7—System Administration

### Detail—Step 1 Commencement

In the embodiment 200 On-Site is the mechanism that Community executives use to engage the embodiment with the Community and the mechanism by which training, professional services and products are delivered to the Community by a Licensed Service Provider in order that the Community remain successful in supporting their use of the embodiment.

A License Service Provider will engage with multiple Community bodies who will be within certain geographical boundaries whose definition will Include, but not be limited to:
Australian Federal government electoral boundaries
Australian State government electoral boundaries
Australian State government boundaries
Australian Local government electoral boundaries
Australian Local government boundaries
Australian Postcodes boundaries
dioceses,
districts,
synods,
clusters,
recruitment boundaries,
leagues

To commence the usage of the embodiment within the Community, a Licensed Service Provider provides services to the Community and the Community executives, which services include but are not limited to the following processes:
201 Feasibility
201 Feasibility is a documentation process directed by the Licensed Service Provider where the Community identifies the needs of Community stakeholders and scopes the current and future value of the usage of the embodiment to the Community.
202 Community Initiation

Contingent upon 201 Feasibility, 202 Community Initiation is a process that includes but is not limited to the following:
1. The Community executes a license agreement with the Licensed Service Provider to obtain non-exclusive rights for the use of the embodiment within their Community.
2. The Licensed Service Provider, in conjunction with the Community, prepares the Community specific branding and broadcasting collateral that includes but is not limited to branding which incorporates the Community Name, Community Logo, Trademarks and Graphical Assets, Community Postal Code and other Community identifiers.

In this embodiment the Community identifier includes: the licensor's logo or trade mark; the Community name, abbreviation and or logo; and the Community postcode generated number or other call sign.
3. The Licensed Service Provider, in conjunction with the Community, configures 500 Server with information about the Community and customlses 500 Server for its desired use within the Community.
203 Trial/Pilot.
203 Trial/Pilot is the process that introduces the embodiment to specific members of the Community to achieve objectives including but not limited to the following:
1. Feedback on the part 2 and 3 of 202 Community Initiation
2. Train the nominated Community expert(s)
3. Publish Digital Media Assets to showcase the embodiment.
204 Subscription Promotion
204 Subscription Promotion is the process of preparing the marketing material and plans which introduce the embodiment and its subscription model to the Community.
205 Community Retail Channel
205 Community Retail Channel allows Community executives to offer third party products and services to the Community for benefit of the Community and Community members. Community executives access and configure this channel through steps that include but are not limited to:
1. Executing a license agreement with the third party(s) to market and sell those third party's product(s) or service(s) within the Community.
2. The Licensed Service Provider or other third parties, in conjunction with the Community, prepares the Community specific branding and marketing collateral that includes but is not limited to branding which incorporates the Community Name, Community Logo, Trademarks and Graphical Assets, Community Postal Code and other Community identifiers.
3. The Licensed Service Provider, in conjunction with the Community, configures 500 Server with information about the product or service offering and customises 500 Server for its desired use within the Community.
206 Launch
206 Launch is the process whereby materials and supporting data from 201 Feasibility, 202 Community Initiation, 203 Trial/Pilot, 204 Subscription Promotion and 205 Community Retail Channel are introduced to the Community, or part thereof, to drive subscription take-up through mechanisms which include but are not limited to:
1. Community Member Information Sessions
2. Community Newsletters, Mail Outs, and Emails
3. Community Executive Briefings
4. Kiosk displays
5. On-Site promotion
207 Marketing Training
The Licensed Service Provider provides training services to the Community executives and other members to optimise 206 Launch.

### Detail—Step 2 Fundraising

In the embodiment 300 On-Going is the commercial model that the Community uses to obtain the required funds to launch and support the on-going use the embodiment within the Community.

The embodiment enables the Community to and collect 301 Funds to provide 105 Financial Support which supports the Community's use of the embodiment. 301 Funds are committed and collected through methods that include but not limited to the following:
302 Subscriptions
On or after 206 Launch, Community members contract to support the use of the embodiment within the Community. Monies associated with this agreement are collected and deposited into 301 Funds and are split between the Community and the Licensed Service Provider as described in agreements executed at 202 Community Initiation Part 1.
303 Commerce
On or after 206 Launch, Community members contract to purchase products and services endorsed by the Community, Monies associated with these agreements are collected and deposited into 301 Funds and are split between the Community and the Licensed Service Provider as described in agreements executed at 202 Community Initiation Part 1 and 205 Community Retail Channel. The services endorsed by the Community include Physical Products including Telecommunication, Computing, AudioNisual, Whitegoods and other retail products, Utility Services. Third Party Content including Sport, News, Music, Interactive Learning, Master Classes, Online Surveys. Loyalty Schemes. Pay per View Content.
304 Donor
On or after 206 Launch, Community members contract to donate funds or other items or services of value to the Community. Monies associated with these donations are collected and deposited into 301 Funds and are split between the Community and the Licensed Service Provider as described in agreements executed at 202 Community Initiation Part 1.
305 Government Funding
On, before or after 206 Launch, Government Bodies agree to provide funds or other items or services of value to the Community. Monies associated with these agreements are collected and deposited into 301 Funds and are split between the Community and the Licensed Service Provider as described in agreements executed at 202 Community Initiation Part 1.
306 Other Funding
On, before or after 206 Launch, other entities agree to provide funds or other items or services of value to the Community. Monies associated with these agreements are collected and deposited into 301 Funds and are split between the Community and the Licensed Service Provider as described in agreements executed at 202 Community Initiation Part 1.

Where the present invention is applied to multiple communities, or applied to multiple members within a community, the associated monies and/or funds may be distributed in correlation with the content associated with each community or each member. Furthermore, this distribution may be biased in accordance with a prescribed behaviour, for example a particular type of content, or may be biased in accordance with content volume or other selected criteria.

### Detail—Step 3 Service Delivery

To support the on-going use of the embodiment within the Community, the Community accesses products and services delivered by the Licensed Service Provider. The Licensed Service Provider, together with Community executive, prepares a service delivery program whose delivery will be financially supported by 105 Financial Support.

The Service Delivery Program includes but is not limited to the following:
208 Equipment Purchase

The extent to that which can be supported by 105 Financial Support, 208 Equipment Purchase is the provision of approved equipment to the Community to support 100 On-Line and 400 On-Air by the Licensed Service Provider.
209 Media Production
The extent to that which can be supported by 105 Financial Support, 209 Media Production is the provision of approved media production services to the Community to support 100 On-Line and 400 On-Air by the Licensed Service Provider.
210 Product/Service Fulfillment
The extent to that which can be supported by 105 Financial Support, 210 Product/Service Fulfillment is the provision of the professional services by the Licensed Service Provider to the Community which enables the Community to establish a fulfillment capability through techniques that include but not limited to:
1. On site fulfillment, either fixed or mobile includes but is not limited to the establishment of or expansion of existing Community point of sale, administrative, informational and promotional facilities including Tuckshop. Bookshop. Uniform Shop. Reception. Foyer. Public Entrance. Community Notice Board. Kiosk Display. Bar. Kitchen. Staff Room. Website. Promotional Vehicle.
2. Offsite fulfillment, either fixed or mobile Includes but is not limited to the establishment of or expansion of existing Community point of sale, administrative, informational and promotional facilities including Publicly located Tuckshop. Bookshop. Uniform Shop. Community Notice Board. Kiosk Display.
211 Subscription Promotion
The extent to that which can be supported by 105 Financial Support, 211 Subscription Promotion is the provision of professional services by the Licensed Service Provider to the Community to secure new subscriptions and sustain repeat subscriptions from Community members.
212 Equipment Training
The extent to that which can be supported by 105 Financial Support, 212 Equipment Training is the provision of training services by the Licensed Service Provider to the Community to optimise the Community's use of media production equipment.
213 Media Skills Training
The extent to that which can be supported by 105 Financial Support, 213 Media Skills Training is the provision of training services by the Licensed Service Provider to the Community to maximise the Community member skills in media production techniques.
214 Content Distribution Training
The extent to that which can be supported by 105 Financial Support, 214 Content Distribution Training is the provision of training services by the Licensed Service Provider to the Community to support the Community executives' content distribution policies as implemented in 500 Server.
215 Marketing Training
The extent to that which can be supported by 105 Financial Support, 215 Marketing Training is the provision of training services by the Licensed Service Provider to the Community to build and sustain the Community's support of the use of the embodiment.

### Detail—Step 4 Content Production

In the embodiment 100 On-Line is the mechanism for communities to 101 Capture and create Digital Media Assets and 001 Publish Content this Digital Media Assets to create content. This is clearly shown in FIG. 2.

Community members and 103 3^{rd} Party Content Providers capture and create Digital Media Assets through the use of media devices which include but not limited to the following:
Video Camera
Still Camera
Scanners
Microphone
Mobile Phone
Personal Digital Assistance (PDA)
Computer

Community members and 103 3^{rd} Party Content Providers' Digital Media Assets are transformed into content by publishing within the embodiment. Publishing can occur from devices capable of connecting to 500 Server which include but not limited to the following:
Mobile Phone
Personal Digital Assistance (PDA)
Computer

These devices contain the embodiment's software programs to publish Digital Media Assets to 500 Server, These software programs allow Community members to:
1. Authenticate themselves as Community members who are authorised to publish to 500 Server.
2. InterCommunity Categorisation: Categorise their Digital Media Assets between relevant Communities as stored within and received from 500 Server
3. Intra-Community Categorisation: Categorise their Digital Media Assets into Community member categories stored within and received from 500 Server.
4. Attach Community, Community member and device identity and other information to their Digital Media Assets.
5. Automatically select the preferred method of transmission to 500 Server based on predefined rules stored within 500 Server.
6. Transmit the Digital Media Assets and other information to 500 Server,
7. Receive receipt or other notification regarding status of transmission to 500 Server.

### Detail—Step 5 Broadcasting

In the embodiment 400 On-Air is the broadcasting process wherein a request for content is received and content is delivered using 500 Server to authorised Community members. The embodiment contains software on 500 Server and on devices capable of connecting to 500 Server which include but not limited to the following:
Mobile Phone
Personal Digital Assistance (PDA)
Computer

These devices enable a Community member to undertake actions including but not limited to the following:
1. Authenticate themselves as Community members who are authorised to direct the distribution of content from 500 Server to other Community members.
2. Authenticate themselves as Community members who are authorised to view content from 500 Server.
3. Select specific content for broadcast to specific Communities and/or Community members.
4. Satisfy the broadcast obligations of the selected specific content, which may include but not be limited to
   Meeting appropriate subscription criteria
   Completing payment for content
   Completing pre-broadcast information provision such as but not limited to surveys or market research.
   Authorising specific Community members to view content
5. Create or select schedules for the broadcast of content to specific Communities and/or Community members
6. Select the method of transmission to be used for the broadcast of content to specific Communities and/or Community members
7. Initiate the broadcast of specific content to specific Communities and/or Community members using the specified method of transmission at the selected schedule.
8. Receive receipt or other notification regarding status of broadcast from 500 Server.

### Detail—Step 6 Collaboration

In the embodiment 100 On-Line and 400 On-Air contains software on devices capable of connecting to 500 Server which include but not limited to the following:
Mobile Phone
Personal Digital Assistance (PDA)
Computer

that enables a Community member the ability to undertake the following collaborative activities to content stored within 500 Server that include but are not limited to the following:
Create
Edit
Mark
Rate
Delete
Amend
Approve
Reject
Review.
Notate
Provide Feedback
Comment
Peer-review

Collaborative activities can occur simultaneously and non-simultaneously between one or more Community members.

### Detail—Step 7 System Administration

In the embodiment, 500 Server provides the user experience, business logic, data storage and the communication, commerce and implementation support network integration required for the entire embodiment to operate.

In the embodiment, the 500 Server user experience layers contains the software that delivers the Community brand, Community identity, Community livery and enables authorised Community Members to customised their user interfaces. The software does this by capturing the required Community and Community Member Information and overlaying that information on pre-defined templates.

The embodiment contains software on 500 Server which enables authorised Community Members to undertake the following business logic actions including but not limited to:
Configure
Administer
Report
Receive
Send

to all data stored within 500 Server.

The embodiment contains software on 500 Server which enables authorised Community members to configure and administer the following elements within 500 Server including but not limited to:
Community Identity
Community Member Groupings
Community Member Identity
Community Member Content Categories
Community Member external Community publishing rights
Other Community and Community Member Data
Content
Content Access Criteria
Collaboration Rules

The embodiment contains software on 500 Server which enables authorised Community members to report on the following elements within 500 Server including but not limited to:
Community Identity
Community Member Groupings
Community Member Identity
Community Member Content Categories
Community Member external Community publishing rights
Other Community and Community Member Data
Content Access Criteria
Community Member Access Logs
Content Access Logs

The embodiment contains software on 500 Server which enables authorised Community members to receive the following elements into 500 Server including but not limited to:
Community Member Groupings
Community Member Identity
Community Member Content Categories
Community Member external Community publishing rights
Other Community and Community Member Data
Content
Content Access Criteria
Collaboration Rules

The embodiment contains software on 500 Server which enables authorised Community members to send the following elements from 500 Server including but not limited to:
Community Member Groupings
Community Member Identity
Community Member Content Categories
Community Member external Community publishing rights
Other Community and Community Member Data
Content
Content Access Criteria
Collaboration Rules

This software does this by receiving instructions from Community administrators and implementing those instructions within 500 Server user experience layer.

In the embodiment, the 500 Server data storage layer contains all the data needed to operate all parts of the system including but not limited to:
Images,
Videos,
Text,
Community Member descriptions

The 500 Server data storage layer software uses information stored within the 500 Server business logic layer to undertake the following action on stored data and Digital Media Assets including but not limited to
Categorise
Index
Maintain
Publish

The 500 Server communication network integration layer contains the software that interacts with the available communication network including, but not limited to
Community LAN connectivity
Community Wi-Fi connectivity
Community Internet connectivity
Third party provided LAN connectivity
Third party provided Wi-Fi connectivity
Third party provided Internet connectivity
Community Member's LAN connectivity
Community Member's Wi-Fi connectivity
Community Members Internet connectivity
Publicly available Telephony networks

The software recognises the source and owner of content published to the system using methods including but not limited to
Identifying the device from which the content originated
Identifying the network used to transmit the content to 500 Server.

In the embodiment, the 500 Server commerce network integration layer contains the software that implements the terms and conditions as determined by the Community. These terms and conditions contain but not limited to the following:
Content and Service Offerings
Content and Service Availability
Content and Service Customisation
Content and Service Training
Content and Service Delivery
Content and Service Pricing
Content and Service Payment Collections
Content and Service Dividend Distribution
Content and Service Access and Permission
Content and Service Auditing and Review
Content and Service Dividend Distribution Auditing
Content and Service Partner Royalty Payment
Content and Service Reporting
Content and Service Loyalty Program

Within the embodiment, the 500 Server implementation support network integration layer manages the delivery of content provided by third parties. This software does this referencing the 500 Server business logic and 500 Server commerce network integration layers to determine which Community members can access specific third party content and then controlling access to and delivery and system usage reporting of third party content.

### Detail—Common Operating Units

The embodiment reuses common or core processes at multiple times within the embodiment but often applied in different contexts or to different data. These Common Operating Units are illustrated within FIG. 3.

### Detail—Common Operating Units—1001 Content Publishing

In the embodiment 1001 Content Publishing is the process by which Content is captured by the system, and published to 500 Server. 1001 Content Publishing contains the following steps:
1001.1 Content Capture/Creation—The capture and creation of new Digital Media Assets through the use of media devices by a Community Member.
1001.2 Existing Content—The reuse of existing Content within the usage of the embodiment to create new or modified content by a Community Member.
1001.3 Content Edit—The edit of 1001.1 Content Capture/Creature content and/or 1001.2 Existing Content for the purposes of creating new or modified content by a Community Member.
1001.4 Security Authentication/Authorisation—The authentication of a Community member which delivers authority to publish to 500 Server.
1001.5 Content Categorisation—The Categorisation of 1001.1 Content Capture/Creation content and/or 1001.2 Existing Content into Community and Community member categories which are stored within and received from 500 Server.
1001.6 Content Publish—The Publish of 1001.1 Content Capture/Creation content and/or 1001.2 Existing Content to 500 Server by attaching Community, Community member and device identity and other information to their 1001.1 Content Capture/Creation content and/or 1001.2 Existing Content
The transmission of published 1001.1 Content Capture/Creation content and/or 1001.2 Existing Content to 500 Server using 1002 Transmission.

### Detail—Common Operating Units—1002 Transmission

In the embodiment 1002 Transmission is the process by which data is transmitted by a Community Member to 500 Server. 1002 Transmission contains the following steps:
1002.1 Mobile—The Community Member uses a mobile device to transmit data to 500 Server. Such mobile devices include but not be limited to the following:
   Mobile Phone
   Personal Digital Assistance (PDA)
1002.2 Fixed—The Community Member uses a fixed device to transmit data to 500 Server. Such fixed devices include but not be limited to the following
   Computer
1002.3 Community Wired/Wireless—Irrespective of the device used to transmit the content, the transmission of the content may occur using the Wired or Wireless network and internet facilities provided by the Community for use on the Community's premises and surrounds. Such Wired and Wireless networks include but not be limited to the following:
   Community provided LAN connectivity
   Community provided Wi-Fi connectivity
   Community provided Internet connectivity
The selection of the Wired or Wireless networks to be used during the transmission of content may be chosen by the Community Member or be determined by the Mobile or Fixed publishing device based on rules stored by and delivered from 500 Server.
1002.4 External Wired/Wireless—Irrespective of the device used to transmit the content, the transmission of the content may occur using a Wired or Wireless network and internet facilities provided by a third party provider or be otherwise available for use by the Community Member outside the Community's premises. Such Wires and Wireless networks include but not be limited to the following:
   Third party provided LAN connectivity
   Third party provided Wi-Fi connectivity
   Third party provided Internet connectivity
   Community Member's LAN connectivity
   Community Member's Wi-Fi connectivity
   Community Member's Internet connectivity
The selection of the Wired or Wireless networks to be used during the transmission of content may be chosen by the Community Member or be determined by the Mobile or Fixed publishing device based on rules stored by and delivered from 500 Server.

### Detail—Common Operating Units—1003 Content Viewing

In the embodiment 1003 Content Viewing is the processed by which a request for content is sent by a Community Member to 500 Server and the content is delivered to Community Members. 1003 Content Viewing contains the following steps:
1003.1 View Content—A Community Member initiates a request to view content within the usage of the embodiment.
1003.2 Security Authentication/Authorisation Refer to 1001.4
1003.3 Content Selection—A Community Member selects the content for viewing.
1003.4 Content Destination—A Community Member explicitly or implicitly selects the destination for the viewing of the content selected by 1003.3 Content Selection. A Destination comprises three components; Destination Audience, Destination Schedule and Destination Output.
A Destination Audience can include but is not limited to
   The Community Member
   Another Community Member
   A group of Community Member's
A Destination Schedule can include but is not limited to:
   Immediate Viewing
   Viewing at a later time and date as set by the Community Member.
A Destination Output can include but is not limited to:
   Mobile Phone
   Personal Digital Assistance (PDA)
   Computer
   Printer or other output device
   Email
Depending on how the request for viewing is initiated with 1003.1 View Content, part or all of the Destination may be implied.
The transmission for the request of content including its Destination is sent to 500 Server using 1002 Transmission.
1003.5 Content Delivered—The delivery of the 1003.3 Content Selection content to the selected 1003.4 Content Destination destination is sent from 500 Server using 1002 Transmission.

### Detail—Common Operating Units—1004 Content Collaboration

In the embodiment, 1004 Content Collaboration is the process by which Community Members collaborate with content stored within the usage of the embodiment. 1004 Content Collaboration contains the following steps:
A Community Member views content delivered by 1003 Content Viewing.
1004.1 Collaborate—A Community Member edits (1001.3 Content Edit) singularly and/or with other Community Members the content delivered by 1003 Content Viewing.
1004.2 Publish Collaborate—Refer 1001.6 Content Publish
The transmission of the published collaboration is sent to 500 Server using 1002 Transmission.

### Detail—Common Operating Units—1005 Content Reporting

In the embodiment, 1005 Content Reporting is the process by which Community Members initiate a request to and view a report on some element stored within the usage of the embodiment. 1005 Content Reporting contains the following steps:
1005.1 Report Content—A Community Member initiates a request to view report on content within the usage of the embodiment.
The report is delivered using 1003 Viewing Content.

### Detail—Common Operating Units—1006 Content Administration

In the embodiment, 1006 Content Administration is the process by which Community Members administer content stored within the usage of the embodiment. 1006 Content Administration contains the following steps:
A Community Member views content delivered by 1003 Content Viewing.
1006.1 Configure/Administer—A Community Member configures and/or administers content delivered by 1003 Content Viewing.
1006.2 Publish Configuration/Administration—Refer 1001.6 Content Publish
The transmission of the configuration and/or administration is sent to 500 Server using 1002 Transmission.

### Detail—Common Operating Units—1007 Content Approval

In the embodiment, 1007 Content Approval is the process by which authorised Community Members approve content stored within the usage of the embodiment for viewing by other Community Members. 1007 Content Approval contains the following steps:
A Community Member views content delivered by 1003 Content Viewing.
1007.1 Approve—A Community Member approves or rejects the content delivered by 1003 Content Viewing for viewing by other Community Members.
1007.2 Publish Approval—Refer 1001.6 Content Publish
The transmission of the approval/rejection is sent to 500 Server using 1002 Transmission.

### Detail—Common Operating Units—1008 Service Access

In the embodiment 1008 Service Access is the processed by which a request for the provision or access of a Service is sent by a Community Member to 500 Server and the Service is delivered to Community Members. A Service can include but is not limited to the following:
Online Survey
Interactive Learning
Interactive Master Classes
Viewing of Third Party Content
Commercial Transaction

1008 Service Access contains the following steps:
1008.1 Access Service—A Community Member initiates a request to access a service within the usage of the embodiment.
1008.2 Security Authentication/Authorisation—Refer to 1001.4
1008.3 Service Selection—A Community Member selects the service for access.
1008.4 Service Destination—A Community Member explicitly or implicitly selects the destination for the accessing the service selected by 1008.3 Service Selection. A Destination comprises three components; Destination Audience, Destination Schedule and Destination Device.
A Destination Audience can include but is not limited to
   The Community Member
   Another Community Member
   A group of Community Member's
A Destination Schedule can include but is not limited to:
   Immediate Viewing
   Viewing at a later time and date as set by the Community Member.
A Destination Device can include but is not limited to:
   Mobile Phone
   Personal Digital Assistance (PDA)
   Computer
Depending on how the request for service access is initiated with 1008.1 Access Service, part or all of the Destination may be implied.
The transmission for the request of service access including its Destination is sent to 500 Server using 1002 Transmission.
1008.5 Service Accessed The access of the 1008.3 Service Selection service to the selected 1008.4 Service Destination destination is sent from 600 Server using 1002 Transmission.

### Detail—Common Operating Units—1009 Marketing Campaign

In the embodiment 1009 Marketing Campaign is the process by which an authorised Community Member prepares and transmits a marketing campaign to 500 Server for delivery by 500 Server to Community Members. A Marketing Campaign includes but is not limited to
Promotion of Community
Promotion of Service
Promotion Loyalty Schemes

1009 Marketing Campaign contains the following steps:
1009.1 Marketing Campaign—A Community Member initiates a request to commence a Marketing Campaign within the usage of the embodiment to Community Members.
The Marketing Campaign is delivered using 1003 Viewing Content.

### Detail—Common Operating Units—1001 External Data Send/Receive

In the embodiment 1010 External Data Send/Receive is the process by which an authorised Community Member can configure the sending or receipt of data from 500 Server with an external entity. Such external entities may include but are not limited to:
Other Community IT assets such as Community Administration Systems, Community Websites and Archival Services.
Third Party Service Providers such as suppliers of Third Party Products and Services and Third Party content and data feeds.

1010 External Data Send/Receive contains the following steps:
1010.1 Send/Receive Data—A Community Member initiates a request to send or receive data with an entity external within the usage of the embodiment.
1010.2 Security Authentication/Authorisation—Refer to 1001.4
1010.3 Data Identification—A Community Member identifies the data to be sent or received.
The transmission for the request of the sending or receiving of data is sent to 500 Server using 1002 Transmission.
1010.4 Data Sent/Received—The transmission of the 1010.3 Data Identification data to/from the selected external entity is undertaken by 500 Server using 1002 Transmission the success of which is reported back to the Community Member.

### COMMUNITY EXAMPLES

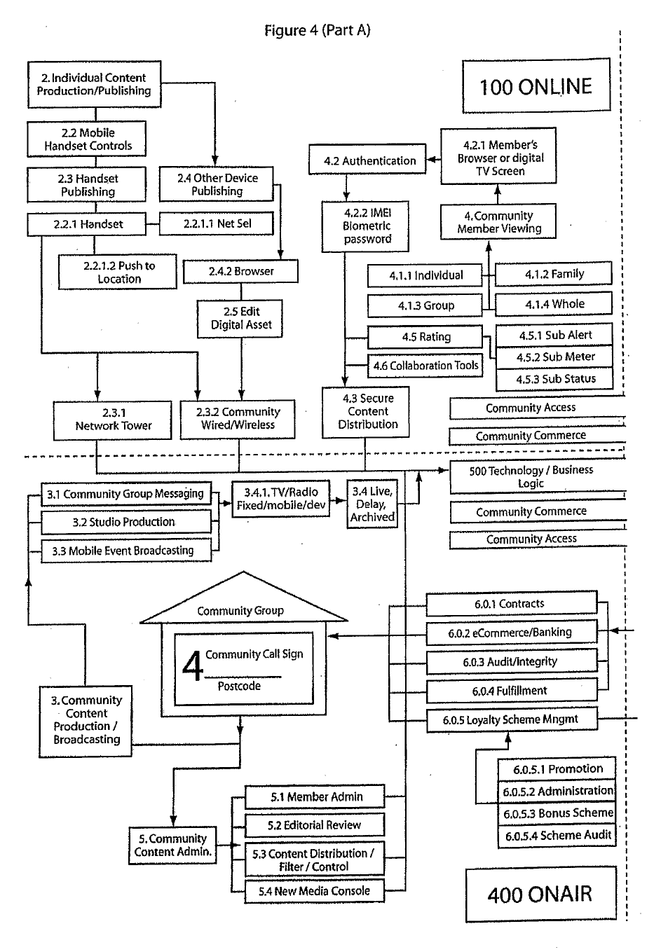

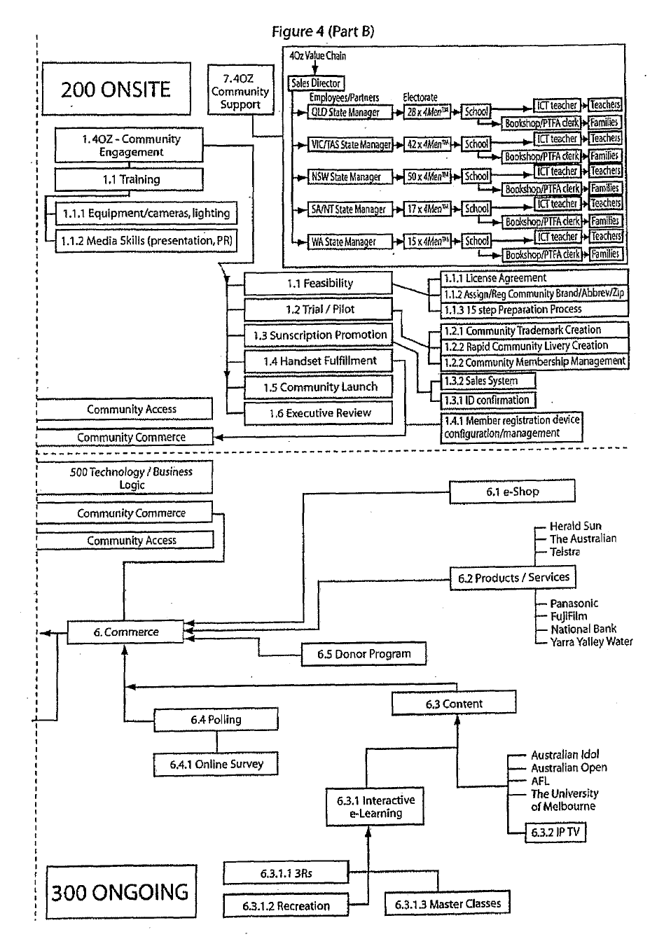

The following Communities represent examples of where the embodiment may be implemented. Reference is to be made to FIG. 1, FIG. 2, FIG. 3 and in particular to FIG. 4. The entire content of FIG. 4 and the remaining figures is hereby incorporated into this section of the specification.

Reference is made to each of the modules and blocks, shown in FIG. 2, by way of the leftmost column in a timeline table detailing a community example of the embodiment described. For example when “PE teacher SMS's to Breaking News to cancel INTERSCHOOL CROSS COUNTRY due to bad weather. Principal reminds parents to register times for PARENT TEACHER interview.” blocks 101, 1001 and 401 are particularly relevant in the process.

School Campus
P-12 Schools

| | |
|---|---|
| Community | Teachers, parents, students and extended family |
| Community Member | Students |
| Subscriber | Parents and extended family |

Day in the Life Of . . .

| | | |
|---|---|---|
| 101, 1001, | 6.45 am | PE teacher SMS's to Breaking News to cancel INTERSCHOOL |
| 401 | | CROSS COUNTRY due to bad weather. Principal reminds |
| | | parents to register times for PARENT TEACHER interview. |
| 401, 1003 | 7.00 am | Students login to School .TV station to view newsletter content, |
| | | breaking news and note CROSS COUNTRY is cancelled |
| 101, 1001, | 7.30 am | Class teacher alerts Year 3 class to bring art equipment/items for |
| 401 | | special project |
| 101, 1001, | 7.40 am | Class teacher sends SMS to Year 12 students wishing them |
| 401 | | ‘good luck’ for practice exams |
| 101, 1001, | 7.48 am | School Bursar alerts via email and SMS parents who have not |
| 401 | | paid CAMP fees |
| 101, 1001, | 7.55 am | School Music Director alerts SCHOOL CHOIR to attend special |
| 401 | | 8.15 warm session before singing in School Assembly |
| 101, 1001, | 8.45 am | Alert generated to extended family of SCHOOL CHOIR soloists |
| 401 | | as a reminder of imminent solo. |
| 101, 1001, | 8.55 am | Live broadcast of SCHOOL CHOIR at School Assembly to |
| 401, 006 | | subscribing parents for ‘live’ streamed video |
| 401, 1003, | 8.56 am | SCHOOL CHOIR's soloist father breaks early morning sales |
| 006 | | team meeting to view 3 minute solo of his daughter |
| 101, 1001, | 9.30 am | Year 8 virtual art gallery photographs are submitted to all child's |
| 1007 | | 4sites. |
| 101, 1001, | 10.30 am | Year 12 Physics video conference to university lecturer on |
| 401, 1003, | | robotics. |
| 1004 | | |
| 101, 1001 | 11.30 am | Chairman of School Council visits to produce School Fete promo |
| | | with 4Oz BDM and year 10 multi-media students |
| 101, 1001, | 11.40 am | Year 7 Environment Studies students arrive at School wetlands |
| 1007 | | location and produce interview and documentary on wetland |
| | | restoration project. Documentary published to class e-portfolio |
| | | review space. |
| 101, 1001, | 11.50 am | Year 10 Sports Science class undertake gymnastic assessments |
| 1007 | | and product 1 minute video of balance beam routine. Video |
| | | published to individual page to contribute to assessment. |
| 209, 101, | 1.00 pm | 4Oz DotKombi mobile van arrives to record, product and |
| 1001 | | broadcast monthly newsletter with principal and Heads of Junior |
| | | School, Sports, Music, Drama and raising volunteer. |
| 401, 1003, | 1.30 pm | Parents of Year 7 Environment Studies students receive email |
| 1005 | | notifying availability of wetlands project documentary. 75% |
| | | review documentary immediately during lunch break. |
| 101, 1001, | 2.00 pm | Year 11 Art class all record 360deg view of major pottery items |
| 1007 | | for show casing in their digital scrap book. |
| 101, 1001, | 2.20 pm | Year 11 Art class attend computer hub to ‘top and tail’ pottery |
| 1007 | | videos before publication to subscribers. |
| 101, 1001, | 3.10 pm | Vice Principal alerts parents of 6 Year 9 boys about detentions |
| 401 | | for bullying during lunchtime. Parents are requested to collect at |
| | | 5.00pm after detention. |
| 1006 | 3.20 pm | Principal contacts Year 9 guardians of girl involved in Family |
| | | Court dispute to confirm immediate dismantling of girl's 4site. |
| 401, 1003, | 3.25 pm | Perth, WA: Grandpa of Year 11 Arts student receives email |
| 102, 1001, | | notification and logins in to granddaughter's 4site to view latest |
| 303, 1008 | | pottery exhibit. Also view last week's .TV station news and |
| | | current affairs noting granddaughter's selection into school |
| | | netball. Records several paragraphs of feedback on pottery item |
| | | and encourages granddaughter to continue. Also orders more |
| | | photos of netball action. |
| 101, 1001, | 3.45 pm | Principal alerts via SMS all pick-up parents' mobiles of 3-car pile- |
| 401 | | up at Gate 2 on school property and resultant traffic. Suggests |
| | | parents enter from alternative road. |
| 212 | 4.00 pm | All Year 5 teachers attend 4Oz professional development |
| | | “Advanced PDA camera skills”. |
| 101, 1003, | 4.10 pm | Netball team attends practice and coach announces selections |
| 401 | | available on Netball 4site. Parent camera operator announced for |
| | | next Saturday morning game. |
| 401, 1003 | 4.30 pm | Year 7 student arrives home and discusses homework with |
| | | mother. Mother logs onto class teacher's diary to review |
| | | homework schedule and helpful reminders on Maths Portal. |
| 401, 1003 | 4.45 pm | Father of Year 11 netballer checks to see if daughter is Netball |
| | | Captain and discovers he is the nominated camera operator for |
| | | this Saturday's game. Cancels Saturday breakfast meeting with |
| | | international CEO to attend Netball game. |
| 401, 1003 | 5.45 pm | During evening meal preparation, mother reviews newsletter and |
| | | Breaking News from School Council Chairman. Is reminded of |
| | | next week's Fete. |
| | 6.40 pm | Father arrives home and congratulates daughter on Netball |
| | | Captain selection. 10 minute discussion on other team members. |
| | 6.45 pm | Father meets Year 7 son and discusses wetland documentary |
| | | and recalls swamp story from youth (no photos, no evidence . . . ) |
| 401, 1003 | 7.45 pm | Parent attends Parent/Teacher interview and view portfolio |
| | | highlights of child's learning and life. Discuss comments with |
| | | teacher. |
| 401, 1003, | 8.15 pm | Four Year 7 Environment Studies students collaborate via secure |
| 102, 1004 | | video to complete group report on bandicoot habitat study. Each |
| | | student takes different role in collaboration including |
| | | photographer, effects, writer and researcher. |
| 101, 1001 | 8.40 pm | Child uploads ‘iMovie” using home broadband of last holiday's |
| | | family Philip Island penguin parade visit to extended family. |
| | | Storyline is included and material is published to subscribers. |
| 401, 1003, | 8.55 pm | ‘Penguin parade” child checks view subscriber log and notes 4 |
| 102, 1004 | | out of 8 relatives have viewed video and submitted comments. |
| | | Responds to comments via email. |

In the above example there is provided a method in which there is provided a method of publishing content associated with members of a school community. In one part the method comprises receiving content associated with the progress and/or achievement of the school children in the form of exhibits of pottery. The content is received and stored online for the purpose of being viewed by the parents of the school children. The parents each have a unique interest in the progress and/or achievement of their specific child. Once stored access to the received content is limited to the parents such that persons exterior to the physical community, that is the wider community, are not able to view the stored content. Furthermore providing access to the stored content to the parents is subject to payment having been received. On payment each of the parents are able to view the stored content and as a result determine the progress and/or achievement of their child while not being able to view the content relating to the other children.

The grouping of parents can be considered to consist of sub-groups of parents each respectively having an interest in a child. In this arrangement the method includes limiting access to the received content from each of the children to their specific parents such that the remaining parents are not provided with access to the stored content.

The content associated with the progress and/or achievement of the school children in the pottery example is generated by the school children.

Tertiary

| | |
|---|---|
| Community | Lecturer, parents, employers, students and |
| | extended family |
| Community Member | Students |
| Subscriber | Parents, students, employers |

Sporting Club
Cricket Club

| | |
|---|---|
| Community | Players, coaches, staff/officials, family and |
| | extended family |
| Community Member | Players |
| Subscriber | Parents and extended family, players, |
| | staff/officials |

Horse Ownership Syndicate

| | |
|---|---|
| Community | Trainers, syndicate managers, racing authorities, |
| | betting authorities |
| Community Member | |
| Subscriber | Syndicate owners |

Week in the Life Of a 3 year old mare called “Horsedotcom”

| | | |
|---|---|---|
| | Monday | Horsedotcom training Bart Freidman picks up IMATE from |
| | 3.45 am | cradle to walk to stables to check Horsedotcom's rehab |
| | | after Saturday's 3-mile debacle. Horsedotcom comes up |
| | | sore. |
| | | Bart downloads emails from 5 of the 12 syndicate owners |
| | | complaining about the jockey's tactics on Saturday's race. |
| 101, 1001, 401 | 4.00 am | Bart Friedman arrives at stables and views Horsedotcom. |
| | | Takes video of Horsedotcom hobbling to stand up. Sends |
| | | video to vet and requests attendance ASAP via SMS. |
| | | Keeps video to show to syndicate if required. |
| 101, 1001, 401, | 4.15 am | Bart Friedman coaxes Horsedotcom for a cold swim in |
| 303 | | river. Videos swim to send to owners and also send them |
| | | an SMS saying that Horsedotcom may be right for next |
| | | race - hold bets. Bart notes low chaff supplies and |
| | | remembers chaff suppliers price increase. Emails all |
| | | syndicate members for monthly fee increase due to rises |
| | | in chaff costs and transportation costs. |
| 401, 1003 | 6.15 am | Bart Friedman returns to stable office after quick review of |
| | | all horses and downloads videos from PDA. Will review |
| | | later and add short description. |
| 101, 1001 | Wednesday | Bart Friedman copies WORD document from vet noting |
| | 1.30 pm | Horsedotcom's clearance to race next Saturday. |
| 101, 1001 | Friday | Bart Friedman records video of last furlong of |
| | 6.15 am | Horsedotcom on 4MP camera phone and pushes to site |
| | | for syndicate members before breakfast. Checks odds at |
| | | TAB and notes odds to syndicate members. |
| 401, 1003, 303, | 8.05 am | 4 Syndicate members login and note Horsedotcom's form |
| 1008 | | and place bet at TAB. |
| 101, 1001, 401 | Saturday | Bart Friedman sends SMS from PDA mobile device to all |
| | 7.00 am | syndicate members that Horsedotcom is frisky and in good |
| | | form. Reminds members to place bets for 1.40pm race. |
| 101, 1001, 401 | 10.00 am | Bart Friedman sends SMS to all syndicate members that |
| | | Horsedotcom has travelled to track and is looking in good |
| | | form. Notes that rival trainer has entered rival horse. |
| 101, 1001, 401 | 1.10 pm | Bart Friedman videos horse in warm-up yard, Sends to 10 |
| | | syndicate owners not at the track. |
| | 1.41 pm | Horsedotcom runs in race and sustains injury. |
| 101, 1001, 401 | 1.45 pm | Horsedotcom pulls up lame and canters into the recovery |
| | | yard. Bart Friedman (concerned about syndicate member's |
| | | response) videos limping horse but re-assures syndicate |
| | | members that the condition is ‘general soreness’. |
| 101, 1001, 401 | 2.45 pm | Bart Friedman SMSs oncourse syndicate members to |
| | | meet at pub ‘Coach and Horses’ to commiserate on |
| | | Horsedotcom's recent form. |

In this embodiment there is provided a system for publishing content associated progress of the condition of the racehorse. The system comprises a module for receiving and storing content directly associated with of condition of the racehorse; a module for limiting access to the stored content to the investors such that the wider community is not able to view the stored content; and a module for allowing the investors to view the stored content, subject to payment, such that the investors are able to view the progress of the condition of racehorse. Other community examples follow in a similar manner. The investors can be considered as being a community subscriber while the racehorse in a member of a wider horse racing and training community.

Church Community

| | |
|---|---|
| Community | Parishioners, church leaders, diocese leaders |
| Community Member | Church family |
| Subscriber | Parishioners |

Extended Family Community

| | |
|---|---|
| Community | Extended family, matriarch/patriarch |
| Community Member | Younger family members |
| Subscriber | Extended family, matriarch/patriarch |

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” when used in this specification is taken to specify the presence of stated features, integers, steps or components but does not preclude the presence or addition of one or more other features, integers, steps, components or groups thereof.” Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

1. A method of enabling communication between member(s) of a community, the method comprising the steps of:
providing content from at least one community member for distribution to at least one other member of the community, providing skills to support the provision of content,
providing financial support for a network adapted to provide the communication, and
providing distribution of the content.

2. A method as claimed in claim 1, further comprising providing additional content derived from outside the community for distribution.

3. A method as claimed in claim 1, further comprising providing control of member(s) access to the content.

4. A method as claimed in claim 1, further comprising providing control of member(s) permission to enable content publishing and/or content viewing.

5. A method as claimed in claim 3, wherein the control is operable from at least one member of the community.

6. A method as claimed in claim 3, wherein the control is provided by configuring a remote device to selectively categorize captured media content prior to transmission of the content to the network.

7. A communications network adapted for enabling communication between member(s) of a community, the network comprising:
first means adapted to providing content from at least one community member for distribution to at least one member of the community,
second means adapted to provide skills to support the first means,
third means adapted to provide financial support for the network, and
fourth means adapted to provide distribution of the content of the first means.

8. A network as claimed in claim 7, further comprising a server adapted to provide an electronic platform enabling operation of the network.

9. A network as claimed in claim 7, wherein the third means further provides additional content derived from outside the community to the fourth means.

10. A network as claimed in claim 7, wherein the fourth means controls member's access to the content.

11. A network as claimed in claim 10, wherein the control comprises content publishing permission and content viewing permission.

12. A network as claimed in claim 7, wherein the first means provides control of the receipt of content from selected member(s).

13. A network as claimed 7, further comprising selective operation of communication between the network and at least one member of the community.

14. A network as claimed in claim 13, wherein the selective operation is provided by configuring a remote device to selectively categorize the captured media content prior to transmission of the content to the network.

15. A network as claimed in claim 14, wherein the selective operation is provided by a configuration file retrieved by the remote device.

16. A device adapted to communicate with a communications network, the device comprising:
first means adapted to capture media content,
second means adapted to transmit the content to the network, and
third means adapted to selectively enable operation the first and/or second means for communication with the network.

17. A device as claimed in claim 16, wherein an applet is provided to the device in order to provide the selective operation.

18. A device as claimed in claim 16, wherein a member of a community can configure the selective operation.

19. A device as claimed in claim 16, wherein the selective operation is provided by a configuration file received by the device.

20. A device as claimed in claim 16, wherein the device is a mobile phone, PDA, and/or a wireless communicable device.

21. A method of categorizing content in a communications device adapted for operation with a community communications network, the community network providing communications between member(s) of the community, the method comprising the steps of:
providing in the device, a first category directed at community access, and a second category directed at a selected group of members access.

22. A method as claimed in claim 21, further comprising the step of providing in the device, a third category directed at a selected member access.

23. A method as claimed in claim 21, wherein the selected member is the user of the device.

24. A method as claimed in claim 21, wherein the device is a PC, mobile phone, PDA, and/or wireless device.

25. A method of publishing content associated with a physical community, the method comprising:
receiving and storing content associated with the progress and/or achievement of a first group of members of the physical community for viewing by a second group of members, the second group having an interest in the progress and/or achievement of the first group of members;
limiting access to the stored content to the second group of members of the physical community such that a third group, exterior to the second group of members of the physical community, is not able to view the stored content; and
subject to payment providing the second group with access to the stored content such that the second group is able to view the stored content and as a result view the progress and/or achievement of the first group of members.

26. A method as claimed in claim 25 wherein the second group of members consists of sub-groups respectively having an interest in a corresponding subgroup of the first group of members and the method includes limiting access to the received content from each of the subgroups of first group of members to the corresponding sub-group of the second group of members such that the remaining sub-groups of the second group are not provided with access to the stored content.

27. A method as claimed in claim 25, wherein the content associated with the progress and/or achievement of a first group of members of the physical community is generated by the first group of members.

28. A method as claimed in claim 27, wherein the first group of members comprises a group of students and the sub-groups of the second group comprise parents and/or extended family of the group of students, each sub-group having an interest in a different one of the group of students.

29. A system for publishing content associated with members of a physical community, the system comprising:
means for receiving and storing content associated with the progress and/or achievement of a first group of members of the physical community;
means for limiting access to the stored content to a second group of members of the physical community, the second group having an interest in the progress and/or achievement of the first group of members, and the access being limited such that a third group, exterior to the second group of members of the physical community, is not able to view the stored content; and
means for allowing the second group to view the stored content, subject to payment, and as a result view the progress and/or achievement of the first group of members.

30. A method of publishing content associated with a physical community, the method comprising:
providing content from at least one community member for distribution to at least one other member of the community or any other community;
correlating access to the content in the community on the basis of payment by the at least one other member of the community for said access.

31. A method as claimed in claim 30, wherein member(s) of one community can publish content to member(s) of another community.

32. A method as claimed in claim 30, wherein control is provided on the publishing choices of members, by limitation or expansion.

33. A method is claimed in claim 30, wherein the basis of payment substantially correlates to the distribution of content.

34. A method of allocating resources between a plurality of communities, the method comprising the steps of:
determining the amount of content communicated to each community, and
allocating the resources in accordance with the determination.

35. A method as claimed in claim 34, wherein the resources are funds raised.

36. A method as claimed in claim 34, wherein the content is pushed to the community.

37. A method as claimed in claim 34, wherein the content is pulled to the community.

38. A method as claimed claim 34, wherein the allocation of resources is applied between a plurality of members of a community.

39. A method as claimed in claim 34, wherein the allocation of resources is applied between a member of one community and a member of another community.

40. (canceled)

41. (canceled)

42. (canceled)

43. (canceled)
